(19) United States
(12) Patent Application Publication
(10) Pub. No.: US 2009/0273154 A1
(43) Pub. Date: Nov. 5, 2009

(54) STEP FOR A VEHICLE

(75) Inventor: Olli Kuula, Goteborg (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/722,048

(22) PCT Filed: Jan. 21, 2005
(86) PCT No.: PCT/SE2005/000066

§ 371 Date: Jun. 18, 2007

(51) Int. Cl. B60R 3/02

(52) U.S. Cl. 280/166

(57) ABSTRACT

A folding step is arranged inside a vehicle door arranged in the cab of a vehicle. The step is connected to a mechanism including a vertical shaft that is connected to the door of the vehicle and is mounted in such a way that it can pivot, which mechanism is arranged to cause the step, during rotation around the vertical shaft, to assume an unfolded or folded-away position when the door of the vehicle is opened or closed.

### BACKGROUND AND SUMMARY

The present invention relates to a step for a vehicle.

Goods vehicles, such as lorries and other heavy vehicles, are currently often provided with steps arranged inside the door to the cab. These are usually permanently mounted in a recess in the side of the cab and are accessible for use after the door has been opened.

A problem with the design described above is that the srecess in which the step is mounted encroaches upon the limited space that is available under the cab, where, among other things, the vehicle' s motor is mounted. This leads to problems, as ever-increasing numbers of components belonging, for example, to the motor and cooling system now need to be fitted in the limited space under the cab of the vehicle.

It is desirable to provide a step arranged inside a vehicle door that is compact and thereby takes up little space.

According to an aspect of the present invention, a folding step is arranged inside a vehicle door arranged on a vehicle cab. According to an aspect of the invention the step is connected to a link arm mechanism that comprises a vertical shaft connected to the door of the vehicle and mounted in such a way that it can rotate, which link arm mechanism is arranged to cause the step to assume an unfolded or folded-away position, by rotating around the said vertical shaft, when the door of the vehicle is opened or closed.

Aspects of the invention provide a plurality of advantages. Primarily, it can be noted that, by means of the construction of an aspect of the invention, a step is obtained that, in its folded-away position, does not encroach upon the limited space that is available under the cab. By means of the location of the step inside the door of the vehicle, a particularly advantageous solution is also obtained, as this location means that the step is well-protected against dirt and other external agents, while at the same time this location is advantageous as far as aerodynamics are concerned.

It is also desirable to provide a step that is designed to be able to be used easily when the door has only been opened a short way. A step according to an aspect of the invention comprises at least one platform constructed of longitudinal and transverse ribs. This platform, that can be used as a step even in a completely folded-away position, is unfolded gradually as the door is opened and is thereby available for use as soon as the door is sufficiently open to give the driver access.

### BRIEF DESCRIPTION OF DRAWINGS

The invention will be described in greater detail in the following with reference to the attached drawings, in which:

FIG. 1 shows a schematic perspective view of how a first embodiment of the present invention can be arranged in the cab of a lorry,

FIG. 2 shows a perspective view of a step according to the present invention in its unfolded position,

FIG. 3 shows a perspective view of the step in FIG. 2 in its folded-away position,

FIG. 4 shows a perspective view of a link arm mechanism that is utilized in the present invention,

FIG. 5 shows a perspective view of a step in its unfolded position according to an alternative embodiment of the present invention.

### DETAILED DESCRIPTION

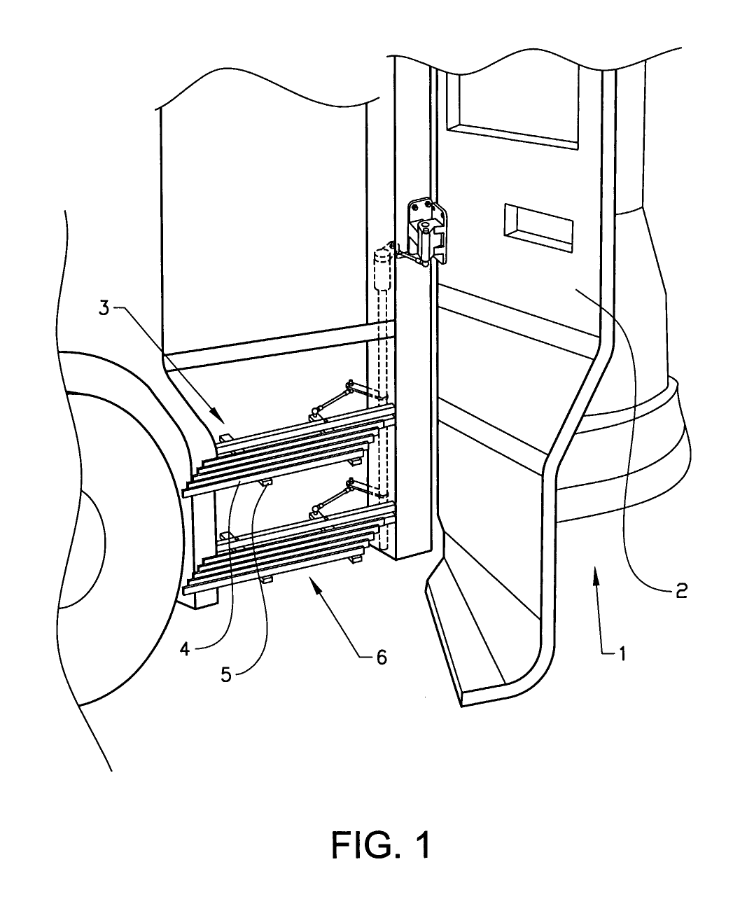

FIG. 1 shows a schematic perspective view of how a first embodiment of the present invention can be arranged inside a vehicle door 2 arranged in the cab 1 of a lorry. The step 3 shown in the figure comprises two platforms 6 that are constructed of longitudinal ribs 4 and ribs 5 that run transverse to these, which platforms together form a folding step. It should, however, be pointed out that the number of platforms 6 forming the step 3 can vary, but is preferably between two and four in number.

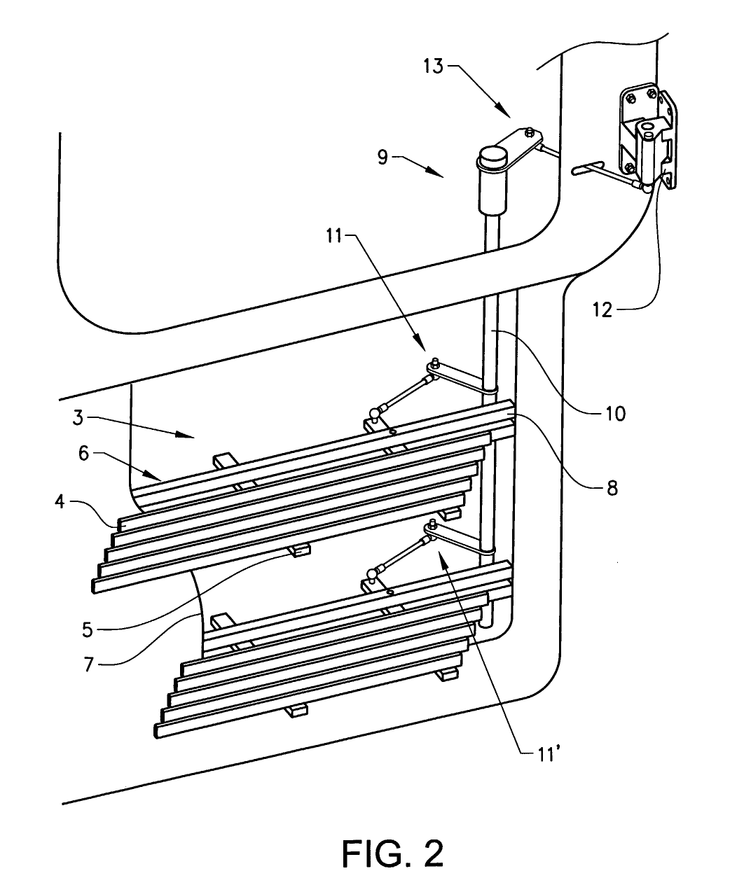

FIG. 2 shows a perspective view of a step 3 according to a preferred embodiment of the invention in its unfolded position. The step 3 is arranged in the cab 1 of the vehicle inside the door 2, and is attached below the door opening of the cab on a track 8 fixed to the frame 7 of the side panel.

The step 3 comprises two platforms 6 constructed of longitudinal ribs 4 and of ribs 5 that are transverse to these, which platforms form a folding step. The longitudinal ribs 4, that are connected to the transverse ribs 5 in such a way that they can pivot, have an orientation that essentially coincides with the longitudinal axis of the vehicle. The transverse ribs 5, that are attached to the track 8 at one end in such a way that they can pivot, are arranged to have an orientation that is essentially at right angles to the longitudinal ribs 4 when the step 3 is fully unfolded.

The step 3 is attached to the door of the vehicle 2 via a link arm mechanism 9. The link arm mechanism 9 comprises a vertical shaft 10 mounted in such a way that it can pivot, to which shaft 10 the platforms 6 of the step are attached via a first link arm arrangement 11, 11′. The upper end of the shaft 10 is attached to the hinge 12 of the door via a second link arm arrangement 13, that interacts with the door 2 of the vehicle to achieve folding away and unfolding of the step 3 by rotation of the shaft 10 in association with closing or opening of the door 2.

FIG. 2 shows the step 3 in the fully unfolded position, that is when the door of the vehicle 2 is fully open. The link arm arrangement 11, 11′ has then rotated the transverse ribs 5 of the platform 6 around the vertical shaft 10 in a clockwise direction to a position where they have an orientation essentially at right angles to the longitudinal ribs 4 of the platform.

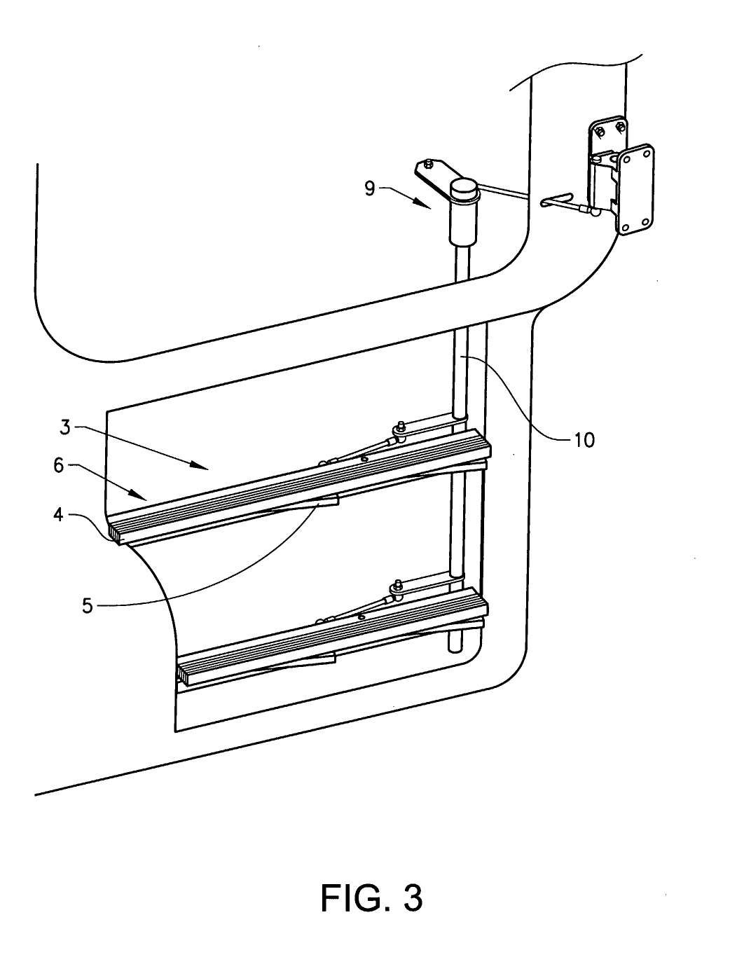

FIG. 3 shows a perspective view of the step 3 in FIG. 2 in its folded-away position. In this position, the door 2, not shown, is fully closed. The link arm mechanism 9 has then rotated the transverse ribs 5 of the platform 6 around the vertical shaft 10 in an anticlockwise direction, to a position where the longitudinal ribs 4 of the platform are slid together and lie close beside each other with an orientation that essentially coincides with the longitudinal axis of the vehicle. The step can be used by the driver even in this position.

The figure shows that, in its folded-away position, the step is very compact and accordingly does not encroach upon the limited space that is available under the cab.

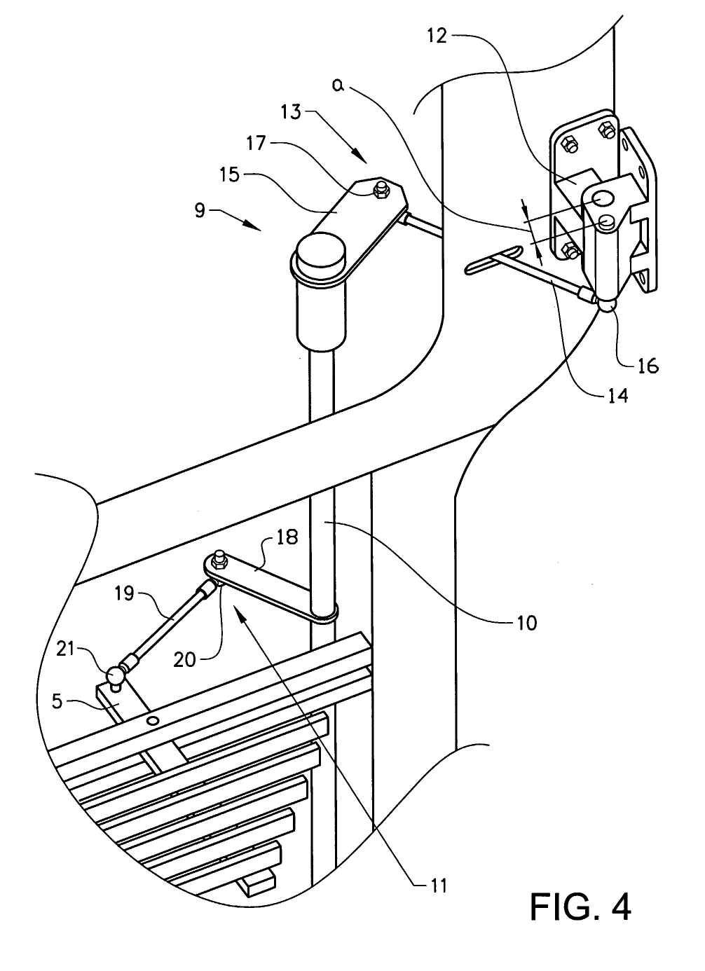

FIG. 4 shows a schematic perspective view of the link arm mechanism 9. The link arm mechanism 9 comprises a second link arm arrangement 13, comprising a first link arm 14 and a second link arm 15, with one end of the first link arm 14 being attached, via a first ball joint 16, to the hinge 12 at a distance a from the centre of rotation of the hinge. The other end of the link arm 14 is attached, via a second ball joint 17, to the link arm 15, which link arm 15 is fixed at its other end to the upper end of the vertical shaft 10. The shaft 10 is attached to the platforms 6 of the step via the link arm arrangement 11, 11′, which link arm arrangement 11, 11′ comprises a first link arm 18 and a second link arm 19, which first link arm 18 is fixed to the shaft 10. At its other end, the link arm 18 is connected, via a first ball joint 20, to the link arm 19, which link arm 19 is connected at its other end, via a second ball joint 21, to one of the transverse ribs 5 of the platform 6.

When the door is opened, its rotational movement is transferred to the shaft 10, via the link arm arrangement 13, which shaft is caused to rotate in a clockwise direction around its vertical axis while the shaft 10 rotates the transverse ribs 5 of the platform, via the link arm arrangement 11, 11′, in a clockwise direction to an unfolded position. In a corresponding way, when the door is closed, the rotational movement of the door is transferred, causing the shaft 10 to rotate in an anticlockwise direction and thereby also cause the transverse ribs of the platform to rotate in an anticlockwise direction.

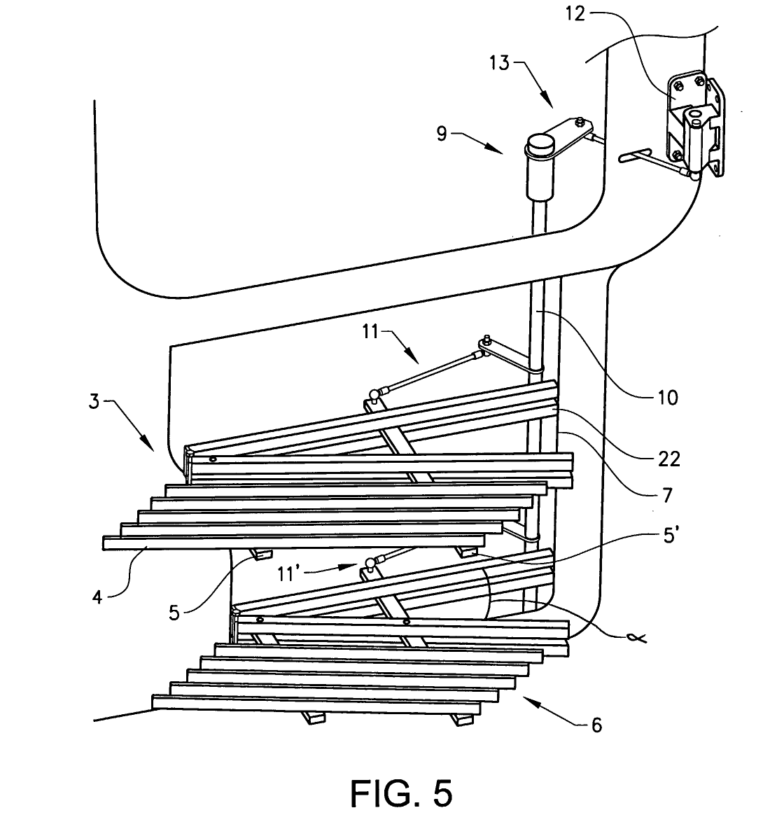

FIG. 5 shows an additional embodiment of the invention. For the sake of clarity, the components that correspond to the components that are shown in FIGS. 1-4 have been given the same reference numerals.

The step 3 comprises two platforms 6, constructed of longitudinal ribs 4 and of ribs 5, 5′ that are transverse to these, which platforms form a folding step. The longitudinal ribs 4 are connected to the transverse ribs 5, 5′in such a way that they can pivot. The step 3 is connected to a slide rail 22 via the transverse ribs 5, 5′ in such a way that it can pivot, which slide rail 22 is fixed to the frame 7 of the side panel, and to which slide rail 22 the transverse rib 5′ is also mounted in such a way that it can slide.

The step 3 is connected to the door of the vehicle 2 via a link arm mechanism 9. The link arm mechanism 9 comprises a vertical shaft 10 mounted in such a way that it can pivot, to which shaft 10 the platforms 6 of the step are connected via a first link arm arrangement 11, 11′. At its upper end, the shaft 10 is connected to the hinge 12 of the door via a second link arm arrangement 13, that interacts with the door 2 of the vehicle to achieve the folding away or unfolding of the step 3 by rotation of the shaft 10 in association with the closing or opening of the door 2.

The figure shows the step 3 in a fully unfolded position, that is when the door of the vehicle is fully open. The link arm arrangement 11, 11′ has then rotated the transverse ribs 5 of the platform 6 around the vertical shaft 10 in a clockwise direction to a position where they have an orientation essentially at right angles to the longitudinal axis of the vehicle, while at the same time the rib 5′ has slid along the slide rail 22 in the direction of travel of the vehicle. The longitudinal ribs 4 of the platform have then been rotated to a position where they form an angle OC with the slide rail 22, where a is between 20 and 35 degrees but is preferably 30 degrees. In their folded-away position, the longitudinal ribs 4 have an orientation that essentially coincides with the longitudinal axis of the vehicle.

The invention is not limited to the embodiment described above and shown in the drawings, but can be varied freely within the framework of the following patent claims. For example, the invention can be used with various types of goods vehicle, such as for example lorries, but can also be used for other types of heavy vehicle, such as wheeled loaders, dumpers, etc.

In the embodiment above, the step is connected mechanically to the door of the vehicle. In another embodiment of the invention (not shown), unfolding and folding away of the steps can alternatively be carried out by an electric motor that is activated by a sensor that detects when the door of the vehicle is opened or closed.

1. A folding step assembly arranged inside a vehicle door of a cab (1) of a vehicle, the folding step assembly comprising a plurality of platforms connected to a link arm mechanism common to the plurality of platforms, the link arm mechanism comprising a vertical shaft that is connected to the door of the vehicle and mounted in such a way that the vertical shaft can pivot, the link arm mechanism being arranged to cause the plurality of platforms, while rotating around the vertical shaft, to all assume an unfolded or folded-away position when the door of the vehicle is opened or closed respectively, and each of the plurality of platforms being constructed of longitudinal and transverse ribs, the longitudinal ribs being slid together and lying beside each other in the unfolded or folded-away position.

2. A step assembly as claimed in claim 1, wherein the link arm mechanism comprises a first link arm arrangement for each platform, and a second link arm arrangement, and the door of the vehicle is connected via the second link arm arrangement to the vertical shaft that is mounted in such a way that it can pivot.

3. A step assembly as claimed in claim 2, wherein each platform is connected via the first link arm arrangement to the sad vertical shaft.

4. A step assembly as claimed in claim 3, wherein the longitudinal ribs are connected to the transverse ribs in such a way that they can pivot, and the longitudinal ribs have an orientation that substantially coincides with a longitudinal axis of the vehicle, and the transverse ribs are arranged to assume an orientation that is substantially at right angles to the longitudinal ribs when the step assembly has assumed its fully unfolded position

5. A step assembly as claimed in claim 2, wherein the so first link arm arrangement comprises a first link arm, fixed at one end to the shaft, and a second link arm, connected at one end to a transverse rib via a ball joint, the first link arm being connected at another end to the second link arm via a ball joint.

6. A step assembly as claimed in claim 2, wherein the second link arm arrangement comprises a first link arm, connected at one end to the hinge of the door of the vehicle via a ball joint, and a second link arm, fixed at one end to the shaft, the first link arm being connected to the second link arm via a ball joint.

7. A step assembly as claimed in claim 1, the step assembly comprising at least two platforms constructed of longitudinal and transverse ribs and disposed in a vertical sequence.

8. A step assembly as claimed in claim 1, wherein the step assembly is attached to a track fixed to a frame of a side panel.

9. A step assembly as claimed in claim 1, wherein the step assembly is connected via the transverse ribs to a slide rail fixed to the frame of the side panel so that the step assembly is adapted to pivot, the transverse rib being arranged to slide along the slide rail.

10. A step assembly as claimed in claim 9, wherein the transverse ribs are arranged, when the step assembly has assumed its fully unfolded position, to assume an orientation that is essentially at right angles to a longitudinal axis of the vehicle, while the longitudinal ribs form an angle a with the slide rail.

11. A step assembly as claimed in claim 10, wherein a size of the angle a lies in the range 20<a<35.

12. A vehicle comprising a vehicle door and a step assembly arranged inside the door of the vehicle as claimed in claim 1.

13. A vehicle as claimed in claim 12, wherein the vehicle is a heavy goods vehicle.

14. A step assembly as claimed in claim 3, wherein the first link arm arrangement comprises a first link arm, fixed at one end to the shaft, and a second link arm, connected at one end to a transverse rib via a ball joint, the first link arm being connected at another end to the second link arm via a ball joint.

15. A step assembly as claimed in claim 3, wherein the second link arm arrangement comprises a first link arm, connected at one end to the hinge of the door of the vehicle via a ball joint, and a second link arm, fixed at one end to the shaft, the first link arm being connected to the second link arm via a ball joint.

16. A step assembly as claimed in claim 3, the step assembly comprising at least two platforms constructed of longitudinal and transverse ribs and disposed in a vertical sequence.

17. A step assembly as claimed in claim 3, wherein the step assembly is attached to a track fixed to a frame of a side panel.

18. A step assembly as claimed in claim 3, wherein the step assembly is connected via the transverse ribs to a slide rail fixed to the frame of the side panel so that the step assembly is adapted to pivot, the transverse rib being arranged to slide along the slide rail.

19. A step assembly as claimed in claim 2, the step assembly comprising at least two platforms constructed of longitudinal and transverse ribs and disposed in a vertical sequence.

20. A step assembly as claimed in claim 2, wherein the step assembly is connected via the transverse ribs to a slide rail fixed to the frame of the side panel so that the step assembly is adapted to pivot, the transverse rib being arranged to slide along the slide rail.
